(19) United States
(12) Patent Application Publication
(10) Pub. No.: US 2016/0096189 A1
(43) Pub. Date: Apr. 7, 2016

(54) FILM-MARGIN ADJUSTER

(71) Applicants: BOE TECHNOLOGY GROUP CO., LTD., Beijing (CN); BEIJING BOE DISPLAY TECHNOLOGY CO., LTD., Beijing (CN)

(72) Inventors: Shoukun WANG, Beijing (CN); Liang SUN, Beijing (CN)

(21) Appl. No.: 14/369,381

(22) PCT Filed: Apr. 2, 2013
(86) PCT No.: PCT/CN2013/073645

§ 371 Date: Jun. 27, 2014

(30) Foreign Application Priority Data
Feb. 22, 2013 (CN) 201310057293.2

(51) Int. Cl. B05C 9/02

(52) U.S. Cl. CPC B05C 9/02

(57) ABSTRACT

A film-margin adjuster, including: four shielding plates, for shielding an area of the peripheral edge-portions of a film-formation substrate respectively; the four shielding plates are oppositely disposed in pairs, and at least one pair of the oppositely disposed shielding plates has a adjustable relative distance therebetween. The film-margin adjuster, by virtue of the at least one pair of the oppositely disposed shielding plates having an adjustable relative distance therebetween, can adjust the area of the peripheral edge-portions of the film-formation substrate shielded by the shielding plates, thus achieving adjustment of the size of film-margin, and improving yield of production line.

### FIELD OF THE INVENTION

The present invention relates to a film-margin adjuster.

### BACKGROUND OF THE INVENTION

On an existing production line for TFT-LCD (Thin Film Transistor-Liquid Crystal Display), a glass substrate is conveyed into a film-formation processing chamber for forming films. As shown in FIG. 1, in a conventional film-formation processing chamber, typically, a shielding-plate frame 20 with fixed location and width is used to adjust film-margin (refer to a distance from a film to an edge of the glass substrate). The glass substrate 21 is placed under the shielding-plate frame 20, and the four rims of the shielding-plate frame 20 shield the peripheral edge portions of the glass substrate 21 respectively, whereas the intermediate portion of the glass substrate 21 not shielded by the shielding-plate frame 20 is used for film-formation, so that the control of film-margin is achieved.

However, because a glass substrate will be shifted during conveyance, after the glass substrate is conveyed into a processing chamber, a shift of the film-margin and uneven formation of films will be caused if the glass substrate is placed at an improper position. This will cause defects to be generated in subsequent exposing and etching processes, and even lead to breakage of the glass substrate, resulting in shut-down of equipments, and thus causing production delays, and affecting productivity and effectiveness of the entire production line.

### SUMMARY OF THE INVENTION

According to an embodiment of the present invention, there is provided a film-margin adjuster, which comprises four shielding plates for shielding an area of peripheral edge-portions of a film-formation substrate respectively, wherein the four shielding plates are oppositely disposed in pairs, and at least one pair of the oppositely disposed shielding plates has a adjustable relative distance therebetween.

In some embodiments, the film-margin adjuster further comprises four fixed rims, which are oppositely disposed in pairs and joined into a fixed frame structure, the four shielding plates are provided on the four fixed rims in one-to-one correspondence, and at least one shielding plate is connected onto the fixed frame structure in a movable manner, and is movable with respect to the shielding plate that is disposed opposite thereto.

Preferably, the film-margin adjuster further comprises a first control device for controlling movement of the at least one pair of the oppositely disposed shielding plates.

Preferably, the film-margin adjuster further comprises a first position-sensing device for acquiring current position information of each of the shielding plates. The current position information of each of the shielding plates, acquired by the first position-sensing device, is provided to the first control device, so that the first control device controls the movement of the at least one pair of the oppositely disposed shielding plates according to the current position information of each of the shielding plates.

The film-margin adjuster may further comprise a first feedback device, which is connected with the first position-sensing device and the first control device respectively, wherein the current position information of each of the shielding plates, acquired by the first position-sensing device, is provided via the first feedback device to the first control device.

In some embodiments, the first position-sensing device is an optical sensor.

Preferably, the film-margin adjuster may further comprise an alignment mechanism for adjusting the position of the film-formation substrate to a predefined position.

For example, the alignment mechanism comprises a moving device for moving the film-formation substrate.

Preferably, the moving device may comprise four clamping structures for clamping and securing four corners of the film-formation substrate respectively, and each of the clamping structures comprises: a fixed bracket, and at least two spindles provided on the fixed bracket and spaced apart for clamping both outside edges of one corner of the film-formation substrate respectively to secure the film-formation substrate.

Preferably, the alignment mechanism may further comprises: a second position-sensing device, for acquiring current position information of the film-formation substrate; and a second control device, connected with the moving device, for controlling the moving device to move the film-formation substrate to a predefined position, according to the current position information of the film-formation substrate acquired by the second position-sensing device.

The film-margin adjuster may further comprises: a second feedback device, connected with the second position-sensing device and the second control device respectively, for providing the position information of the film-formation substrate acquired by the second position-sensing device to the second control device.

In some embodiments, the second position-sensing device is an optical sensor.

Preferably, the moving device further comprises: a driving structure, connected with the second control device, for driving the moving device to move the film-formation substrate, under the control of the second control device.

The driving structure may be an electric or pneumatic driving structure.

### BRIEF DESCRIPTION OF THE DRAWINGS

In order to clearly illustrate the technical solutions of the embodiments of the invention, the drawings showing the embodiments will be briefly described in the following. It is obvious that the described drawings are only related to some embodiments of the invention and thus are not limitative of the invention.

FIG. 1 shows a schematic diagram of a shielding-plate frame in the prior art;

FIG. 2 shows a schematic structural diagram of an embodiment of the film-margin adjuster provided by the present invention;

FIG. 3 shows a schematic structural diagram of another embodiment of the film-margin adjuster provided by the present invention;

FIG. 4 shows a schematic structural diagram of a moving device in the film-margin adjuster provided by the present invention.

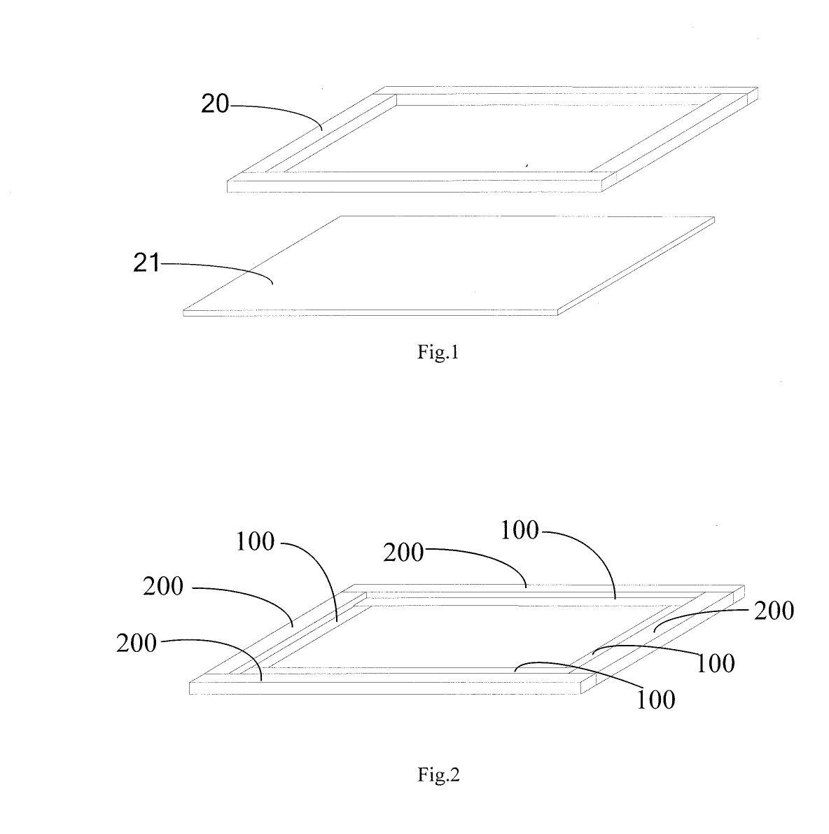

### DETAILED DESCRIPTION OF THE PREFERRED EMBODIMENTS

The principles and features of the present invention will be described below with reference to the drawings. The examples described are only for the purpose of explaining the present invention, but not intended to limit the scope of the invention.

According to an embodiment, there is provided a film-margin adjuster, which can achieve adjustment of the size of film-margin, during film-formation on a glass substrate that is conveyed into a film-formation processing chamber, on a TFT-LCD production line.

As shown in FIG. 2, the film-margin adjuster provided in this embodiment comprises: four shielding plates 100, for shielding the area of the peripheral edge-portions of a film-formation substrate respectively. The four shielding plates 100 are oppositely disposed in pairs, and the oppositely disposed shielding plates 100 have an adjustable relative distance therebetween.

With the above solution, the four shielding plates 100 for shielding the area of the peripheral edge-portions of the film-formation substrate, are designed as such a structure in which the oppositely disposed shielding plates 100 have an adjustable relative distance therebetween. After the film-formation substrate (e.g., a glass substrate) is conveyed into a film-formation processing chamber, since the portion on the film-formation substrate non-shielded by the shielding plates 100 is used for film-formation, by adjusting the relative distance between the oppositely disposed shielding plates 100, the shielded area of the peripheral edge-portions of the film-formation substrate by the shielding plates 100 can be adjusted. Thus, the control of the size of film-margin during film-formation can be achieved, thereby meeting design requirements and improving yield of production line.

It should be noted that, in the film-margin adjuster provided in this embodiment, among the two pairs of oppositely disposed shielding plates 100, there may be one pair of the oppositely disposed shielding plates 100 that has an adjustable relative distance therebetween. It is also possible that both the two pairs of oppositely disposed shielding plates 100 have an adjustable relative distance therebetween, respectively.

Specifically, as shown in FIG. 2, the film-margin adjuster provided in this embodiment, is configured to further comprise: four fixed rims 200, which are oppositely disposed in pairs and joined into a fixed frame structure; and the fixed frame structure is to be held above the film-formation substrate. The four shielding plates 100 are provided on the four fixed rims 200 in one-to-one correspondence; and at least one shielding plate 100 is connected to the fixed frame structure in a movable manner, and can move with respect to the shielding plate 100 disposed opposite thereto.

In this embodiment, preferably, as shown in FIG. 2, the four fixed rims 200 of the fixed frame structure each are provided thereon with a rail respectively; each of the shielding plates 100 has its one lateral side inserted into the corresponding fixed rim 200, with the both ends being movably connected in the rails of two fixed rims 200 disposed adjacent thereto respectively. Thus, each of the shielding plates 100 can move along the rails of two fixed rims 200, to which its both ends are connected, to adjust the distance between itself and the shielding plates 100 disposed opposite thereto (i.e., each of the shielding plates 100 can adjust its shielding width), so as to adjust the shielded area of the peripheral edge-portions of the film-formation substrate. It should be noted that, in other embodiments, the four shielding plates 100 may adopt other structures to achieve adjustable relative distance between oppositely disposed shielding plates 100. Description of such embodiments is omitted herein.

In addition, the film-margin adjuster can control the movement of each of the shielding plates 100 through manual manipulation. Preferably, the film-margin adjuster provided in this embodiment can further comprise: a first control device (not shown), for controlling the movement of each of the shielding plates 100. With the first control device, it is possible to precisely control the movement of the shielding plate 100.

In addition, in order to further precisely control the movement of the shielding plates 100 so as to achieve precise control of the size of film-margin, in this embodiment, preferably, the film-margin adjuster can further comprise: a first position-sensing device (not shown), for acquiring current position information of each of the shielding plates 100.

A first feedback device (not shown) is connected with the first position-sensing device and the first control device respectively, for feeding back the current position information of each of the shielding plates 100 to the first control device, so that the first control device controls the movement of the shielding plates 100, according to the current position information of each of the shielding plates 100.

With the above solution, the first position-sensing device acquires the current position information of each of the shielding plates 100, then the first feedback device feeds back the current position information of each of the shielding plates 100 to the first control device, and then the first control device controls the movement of each of the shielding plates 100, according to the current position information of each of the shielding plates 100, so that each of the shielding plates 100 is accurately controlled to be moved to a proper position.

It should be noted that, in this embodiment, the first position-sensing device can be an optical sensor, which is used to sense the position of each of the shielding plates 100. Certainly, in other embodiments, the first position-sensing device can be implemented with other devices.

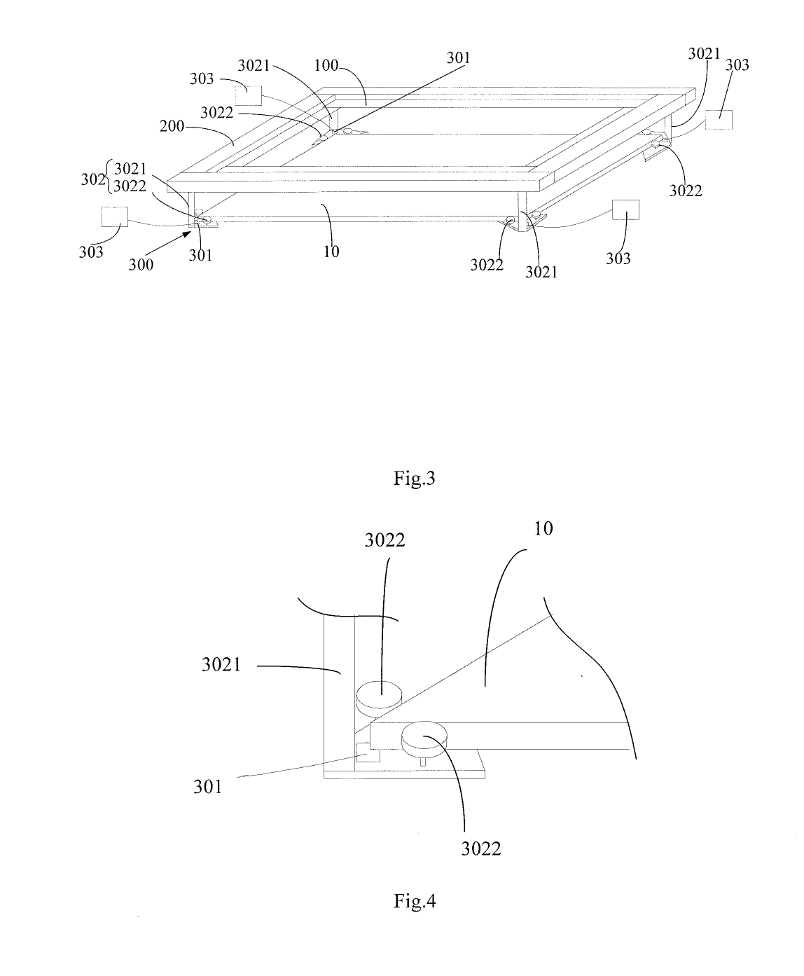

In addition, in this embodiment, since the film-formation substrate is likely to be shifted in position as it is conveyed into a film-formation processing chamber, a deviation may still occur if the film-margin is controlled only by moving the shielding plates 100. Therefore, in order to further ensure the precision of film-margin control, in this embodiment, as shown in FIG. 3, preferably, the film-margin adjuster further comprises an alignment mechanism 300 for adjusting the position of the film-formation substrate to a predefined position.

In this embodiment, preferably, as shown in FIG. 3, the alignment mechanism 300 can comprise: a second position-sensing device 301, for acquiring the current position information of the film-formation substrate 10; a moving device 302 for moving the film-formation substrate 10; a second control device (not shown), connected with the moving device 302, for controlling the moving device 302 to move the film-formation substrate 10 to a predefined position, according to the current position information of the film-formation substrate 10; and a second feedback device 303, connected with the second position-sensing device 301 and the second control device respectively, for feeding back the position information of the film-formation substrate 10 to the second control device.

With the above solution, the second position-sensing device 301 acquires the current position information of the film-formation substrate 10, then the current position information of the film-formation substrate 10 is fed back via the second feedback device 303 to the second control device, and then the second control device sends control signals to the moving device 302, according to the current position information of the film-formation substrate 10, and the moving device 302 in turn moves the film-formation substrate 10 to a predefined position.

It should be noted that, the second position-sensing device 301 can be an optical sensor, which acquires the current position information of the film-formation substrate 10. It should also be noted that, in a preferred embodiment of the present invention, the first position-sensing device and the second position-sensing device 301 can be the same device, which simultaneously acquires the position information of the shielding plates 100 and of the film-formation substrate 10.

In addition, the first control device and the second control device may also be integrated as the same control device, which can firstly control the film-formation substrate 10 to move to a predefined position, and then according to the positions of the shielding plates 100, control the shielding plates 100 to move to proper positions, so as to achieve automatic adjustment of the size of film-margin.

In addition, it should also be noted that, in this embodiment, the predefined position of the film-formation substrate 10 is preferably a position where the film-formation substrate 10 is located at an intermediate position of the fixed frame structure.

In addition, in this embodiment, the moving device 302 for moving the film-formation substrate 10 can be a variety of structures. In one example of this embodiment shown in FIG. 3 and FIG. 4, the moving device 302 comprises:

four clamping structures, for clamping and securing the four corners of the film-formation substrate 10 respectively, wherein each of the clamping structures comprises: a fixed bracket 3021, and two spindles 3022 provided on the fixed bracket 3021 and spaced apart; and

a driving structure (not shown), connected with the second control device, for driving the spindles 3022 to spin at both outside edges of one corner of the film-formation substrate 10, so as to move the film-formation substrate 10 under the control of the second control device.

The fixed bracket 3021 in each of the clamping structures is used to be fixed to the four corners of the fixed frame structure. The two spindles 3022 in each of the clamping structures are spaced apart, so that each corner of the film-formation substrate 10 can be disposed between the two spindles 3022. Thus, as shown in FIG. 3 and FIG. 4, the two spindles 3022 can be provided to clamp both outside edges of one corner of the film-formation substrate 10 respectively, so as to clamp and secure the film-formation substrate 10. The driving structure is used to drive the spindles 3022 to spin under the control of the second control device. Since the spindles are provided to clamp both outside edges of one corner of the film-formation substrate 10, spinning of the spindles 3022 will urge the edges of the film-formation substrate 10, so as to urge the film-formation substrate 10 to move. With the above structure, the fitting relationship between the spindles 3022 and the film-formation substrate 10 is that: the spindles 3022 are in contact with both outside edges of one corner of the film-formation substrate 10, and the spindles 3022 spin to urge the film-formation substrate 10; and therefore, such a fitting mode can ensure that no adverseness will be generated during the movement of the film-formation substrate 10. It should be noted that, in this embodiment, the driving structure can be an electric or pneumatic driver.

In addition, it should also be noted that, in other embodiments, the moving device 302 is not limited to the structure described above, but can be other structures. For example, two clamping arms can be used to clamp the film-formation substrate 10, and a driving structure can be used to drive the clamping arms to move the film-formation substrate 10. Detailed description in this regard is omitted herein.

In summary, the film-margin adjuster provided in the embodiments of the present invention, can achieve adjustment of the alignment of the film-formation substrate 10. Such adjustment of the alignment can be performed in real time. In addition, it is also possible to adjust the shielding area of the shielding plates 100 automatically, thereby achieving automatic adjustment of the size of film-margin, during a film-forming process on the film-formation substrate 10 that is conveyed into a film-formation processing chamber on a production line, and thus design requirements are satisfied and product yield is improved.

In order to make the objects, technical details and advantages of the embodiments of the present invention more clear, the technical solutions of the embodiments have been described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without inventive labor, which should be within the scope of the invention.

1. A film-margin adjuster, comprising:
four shielding plates, for shielding an area of peripheral edge-portions of a film-formation substrate respectively, wherein the four shielding plates are oppositely disposed in pairs, and at least one pair of the oppositely disposed shielding plates has a adjustable relative distance therebetween.

2. The film-margin adjuster according to claim 1, further comprising four fixed rims, which are oppositely disposed in pairs and joined into a fixed frame structure,
wherein the four shielding plates are provided on the four fixed rims in one-to-one correspondence; and at least one shielding plate is connected onto the fixed frame structure in a movable manner, and is movable with respect to the shielding plate that is disposed opposite thereto.

3. The film-margin adjuster according to claim 1, further comprising a first control device for controlling movement of the at least one pair of the oppositely disposed shielding plates.

4. The film-margin adjuster according to claim 3, further comprising a first position-sensing device for acquiring current position information of each of the shielding plates,
wherein the current position information of each of the shielding plates, acquired by the first position-sensing device, is provided to the first control device, so that the first control device controls the movement of the at least one pair of the oppositely disposed shielding plates according to the current position information of each of the shielding plates.

5. The film-margin adjuster according to claim 4, further comprising a first feedback device, which is connected with the first position-sensing device and the first control device respectively,
wherein the current position information of each of the shielding plates, acquired by the first position-sensing device, is provided via the first feedback device to the first control device.

6. The film-margin adjuster according to claim 4, wherein the first position-sensing device is an optical sensor.

7. The film-margin adjuster according to claim 2, further comprising an alignment mechanism for adjusting the position of the film-formation substrate to a predefined position.

8. The film-margin adjuster according to claim 7, wherein the alignment mechanism comprises a moving device for moving the film-formation substrate.

9. The film-margin adjuster according to claim 8, wherein the moving device comprises four clamping structures for clamping and securing four corners of the film-formation substrate respectively, and each of the clamping structures comprises: a fixed bracket, and at least two spindles provided on the fixed bracket and spaced apart for clamping both outside edges of one corner of the film-formation substrate respectively to secure the film-formation substrate.

10. The film-margin adjuster according to claim 8, wherein the alignment mechanism further comprises:
a second position-sensing device, for acquiring current position information of the film-formation substrate; and
a second control device, connected with the moving device, for controlling the moving device to move the film-formation substrate to a predefined position, according to the current position information of the film-formation substrate acquired by the second position-sensing device.

11. The film-margin adjuster according to claim 10, wherein the film-margin adjuster further comprises:
a second feedback device, connected with the second position-sensing device and the second control device respectively, for providing the position information of the film-formation substrate acquired by the second position-sensing device to the second control device.

12. The film-margin adjuster according to claim 10, wherein the second position-sensing device is an optical sensor.

13. The film-margin adjuster according to claim 10, wherein the moving device further comprises:
a driving structure, connected with the second control device, for driving the moving device to move the film-formation substrate, under the control of the second control device.

14. The film-margin adjuster according to claim 13, wherein, the driving structure is an electric or pneumatic driving structure.

15. The film-margin adjuster according to claim 2, further comprising a first control device for controlling movement of the at least one pair of the oppositely disposed shielding plates.

16. The film-margin adjuster according to claim 15, further comprising a first position-sensing device for acquiring current position information of each of the shielding plates,
wherein the current position information of each of the shielding plates, acquired by the first position-sensing device, is provided to the first control device, so that the first control device controls the movement of the at least one pair of the oppositely disposed shielding plates according to the current position information of each of the shielding plates.

17. The film-margin adjuster according to claim 16, further comprising a first feedback device, which is connected with the first position-sensing device and the first control device respectively,
wherein the current position information of each of the shielding plates, acquired by the first position-sensing device, is provided via the first feedback device to the first control device.

18. The film-margin adjuster according to claim 1, further comprising an alignment mechanism for adjusting the position of the film-formation substrate to a predefined position.

19. The film-margin adjuster according to claim 18, wherein the alignment mechanism comprises a moving device for moving the film-formation substrate.

20. The film-margin adjuster according to claim 19, wherein the moving device comprises four clamping structures for clamping and securing four corners of the film-formation substrate respectively, and each of the clamping structures comprises: a fixed bracket, and at least two spindles provided on the fixed bracket and spaced apart for clamping both outside edges of one corner of the film-formation substrate respectively to secure the film-formation substrate.
